(19) United States
(12) Patent Application Publication
(10) Pub. No.: US 2025/0292147 A1
(43) Pub. Date: Sep. 18, 2025

(54) MACHINE LEARNING MULTIMEDIA ACCELERATOR

(71) Applicant: Google LLC, Mountain View, CA (US)

(72) Inventors: Scott Wang-Yip Cheng, Foothill Ranch, CA (US); Yang Yang, Sunnyvale, CA (US); Injae Yoo, San Jose, CA (US)

(21) Appl. No.: 18/603,986

(22) Filed: Mar. 13, 2024

(51) Int. Cl. G06N 20/00

(52) U.S. Cl. CPC G06N 20/00

(57) ABSTRACT

Methods, systems, and apparatus, including computer programs encoded on computer storage media, for machine learning multimedia hardware acceleration. One of the methods includes retrieving multimedia data using a multimedia hardware accelerator of a first compute cluster of a system on a chip, wherein the first compute cluster includes (i) the multimedia hardware accelerator and (ii) one or more matrix processors that perform machine learning operations; performing a first set of operations using the multimedia hardware accelerator of the first compute cluster and the retrieved multimedia data, wherein the first set of operations include pre-processing the retrieved multimedia data, wherein the multimedia hardware accelerator includes circuit elements that are each configured to perform a respective operation in the first set of operations; processing, using the one or more matrix processors of the first compute cluster, the pre-processed multimedia data; and generating, by processing the pre-processed multimedia data, a model trained for predicting features of subsequent multimedia data.

### BACKGROUND

Machine learning requires computational resources to generate and process data. Because of the vast amounts of data to be processed, increased efficiency in performing one or more operations can result in significant overall performance improvements which can be represented in decreased latency or reduced power consumption for a machine learning process.

### SUMMARY

In general, one innovative aspect of the subject matter described in this specification can be embodied in methods that include the actions of retrieving multimedia data using a multimedia hardware accelerator of a first compute cluster of a system on a chip, wherein the first compute cluster includes (i) the multimedia hardware accelerator and (ii) one or more matrix processors that perform machine learning operations; performing a first set of operations using the multimedia hardware accelerator of the first compute cluster and the retrieved multimedia data, wherein the first set of operations include pre-processing the retrieved multimedia data, wherein the multimedia hardware accelerator includes circuit elements that are each configured to perform a respective operation in the first set of operations; processing, using the one or more matrix processors of the first compute cluster, the pre-processed multimedia data; and generating, by processing the pre-processed multimedia data, a model trained for predicting features of subsequent multimedia data. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination. Feature 1: The one or more matrix processors of the first compute cluster can include a Tensor Processing Unit (TPU). Feature 2: Performing the first set of operations using the multimedia hardware accelerator of the first compute cluster can include compressing or decompressing the retrieved multimedia data. Feature 3: Performing the first set of operations using the multimedia hardware accelerator of the first compute cluster can include one or more of the following: cropping, rotating, color space conversions, normalization, downscaling, reading to memory, or writing to memory. Feature 4: Performing the first set of operations using the multimedia hardware accelerator of the first compute cluster can include (i) cropping, (ii) rotating, (iii) color space conversions, (iv) normalization, (v) downscaling, (vi) reading to memory, and (vii) writing to memory.

The technology described in this specification can be implemented so as to realize one or more of the following advantages. For example, techniques for a multimedia hardware acceleration can reduce latency and power usage for machine learning operations performed by a computing system, such as a system on a chip. Latency and power usage improvements can be achieved, at least in part, by combining one or more ASICs implementing techniques of a multimedia hardware acceleration with one or more machine learning processors, such as a CPU, GPU, or TPU, within a computer cluster of a system, e.g., such as a subsystem of a system on a chip. Such techniques can reduce latency and decrease power usage by offloading processing operations from more general purpose processors, such as CPU, GPU, or TPU, to more efficient processors of one or more ASICs. Techniques can decrease a number of read and writing operations to storage devices performed during machine learning operations, e.g., by manufacturing one or more ASICs implementing techniques of a multimedia hardware acceleration within a subsystem of a system on a chip that also includes a more general purpose processor for machine learning operations, such as a CPU, GPU, or TPU where different subsystems communicate over busses or storage devices that would increase latency or read and write operations to storage devices.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example machine learning multimedia accelerator system.

FIG. 2 shows latency improvements of the described techniques compared with a non-multimedia hardware accelerator approach.

FIG. 3 is a flowchart of an example process for multimedia hardware acceleration.

FIG. 4 is a diagram illustrating an example of a computing system used for multimedia hardware acceleration.

Like reference numbers and designations in the various drawings indicate like elements.

### DETAILED DESCRIPTION

Techniques described can reduce area, power usage, and latency for performing machine learning. For example, machine learning can be performed using one or more graphics processing units (GPUs) or central processing units (CPUs). In some cases, one or more matrix processors can be used for performing machine learning. The matrix processors can include specialized elements for neural network workloads which can increase computational throughput. These matrix processors can include hardware elements configured to perform multiply or accumulate operations. Examples of matrix processors include Tensor Processing Units (TPUs) developed by GOOGLE. A TPU can be a type of application-specific integrated circuit (ASIC). Techniques described can accelerate machine learning processes by performing one or more operations using one or more ASICs before or after processing by machine learning processors, such as a GPU, CPU, or TPU. In some cases, hardware elements implementing techniques for acceleration described in this document can be located in a subsystem of a chip together with a machine learning processor, such as a GPU, CPU, or TPU. By locating the hardware elements in the same subsystem, area, power usage, and latency for performing machine learning can be reduced—e.g., by reducing read and write processes to and from a storage device while processing data for machine learning. In some cases, transfers to or from dynamic random-access memory (DRAM) can be reduced by using one or more ASICs within a same subsystem as a GPU, CPU, or TPU configured to perform machine learning operations.

In some implementations, techniques are performed by a multimedia hardware accelerator. The multimedia hardware accelerator can include one or more ASICs. The multimedia hardware accelerator can include one or more hardware blocks that can perform pre or post-processing of input or output data, such as multimedia data. In some cases, the multimedia hardware accelerator performs operations that are frequently used for machine learning operations and uses fixed functional hardware to reduce area or power costs for performing the operations.

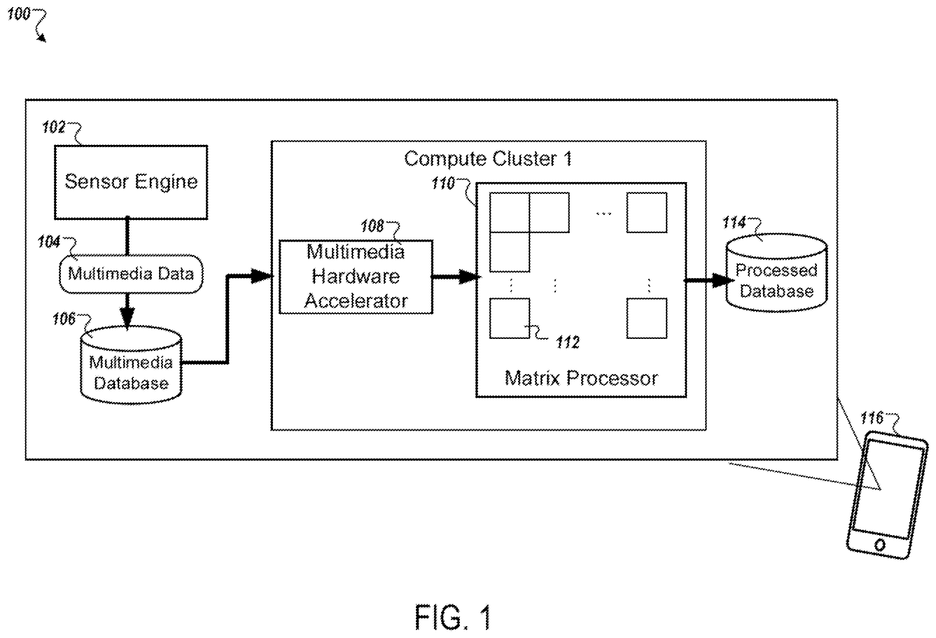

FIG. 1 shows an example machine learning multimedia accelerator system 100. The system 100 includes a sensor engine 102, a multimedia database 106, a multimedia hardware accelerator 108, a matrix processor 110, a processed database 114, and a device 116. The device 116 can be a mobile device, such as a smartphone. The device 116 can include one or more hardware circuits configured to perform operations described in regard to the system 100.

In general, the multimedia hardware accelerator 108 of the system 100 can improve the area, power costs, and latency of machine learning operations. Machine learning operations can include processing, using one or more machine learning models, one or more items of data, comparing processed results to one or more ground truth labels, and adjusting one or more weights or parameters in the one or more machine learning models.

Although shown performing pre-processing of data prior to processing by the matrix processor 110, the multimedia hardware accelerator 108 can perform post-processing either instead of, or in addition to, pre-processing. Post-processing can include obtaining data from the matrix processor 110 and processing the data by performing one or more operations on the obtained data, e.g., prior to storage or sending to another processing element.

The matrix processor 110 can be replaced with other machine learning processing elements. For example, instead of a matrix processor, such as a TPU, the system 100 can include a CPU or GPU that performs machine learning operations either before or after processing by the multimedia hardware accelerator 108.

The sensor engine 102 obtains one or more items of sensor data. The sensor data can include multimedia data 104. The multimedia data 104 can include data collected by a sensor of the sensor engine 102. Sensors can include a camera, a microphone, an accelerometer, a proximity sensor, among others. Sensors can be configured on a smartphone or other device, e.g., the device 116.

The sensor engine 102 provides the multimedia data 104 to the multimedia database 106. The multimedia database 106 can include any suitable storage device. The multimedia database 106 can include random access memory, memory units of a system on a chip, among others. In some cases, the sensor engine 102 generates an adjusted version of the multimedia data 104 for storing in the multimedia database 106. For example, the sensor engine 102 can compress the multimedia data 104 before storing the compressed version of the multimedia data 104 in the multimedia database 106.

The multimedia hardware accelerator 108 can retrieve the multimedia data 104. For example, the multimedia hardware accelerator 108 can retrieve the multimedia data 104 from the multimedia database 106. In some cases, the multimedia hardware accelerator 108 can access a type of random access memory, such as dynamic random access memory, to retrieve the multimedia data 104.

The multimedia hardware accelerator 108 can be configured as one or more hardware elements in a same compute cluster with a machine learning processor. A compute cluster can refer to a subsystem of a system on a chip. A compute cluster can include elements within a system on a chip architecture that share a storage device. In the example of FIG. 1, the machine learning processor includes the matrix processor 110. In some implementations, the machine learning processor includes a CPU, GPU, or TPU. For example, the multimedia hardware accelerator 108 can pre-process data for the machine learning processor or perform post-processing for data processed by the machine learning processor.

The multimedia hardware accelerator 108 can perform read and write direct memory access operations, e.g., for YUV420. YUV420 can include PVRIC compression or decompression, e.g., where the multimedia hardware accelerator 108 can perform one or more operations of compression or decompression. The multimedia hardware accelerator 108 can perform chroma upsampling or downsampling. For example, the multimedia hardware accelerator 108 can perform chroma upsampling from YUV420 to YUV444 or chroma downsampling from YUV444 to YUV420. The multimedia hardware accelerator 108 can perform strided access for compressed and uncompressed YUV420—e.g., stride can represent a width of a frame buffer used in an image or other data. Stride can be wider than an image size. For example, stride can be 2048 bytes or pixels, but an image of FHD can be 1980 pixel wide.

In some implementations, the multimedia hardware accelerator 108 performs one or more multimedia operations. For example, the multimedia hardware accelerator 108 can perform one or more of the following: downscaling, cropping, format conversion, rotation, or the like. In general, the multimedia hardware accelerator 108 can perform operations on data to be processed, or already processed, by the matrix processor 110 so that the matrix processor 110 does not have to perform those operations.

In some implementations, the multimedia hardware accelerator 108 performs operations that include one or more of the following: cropping, rotation (e.g., 90, 180, 270 degrees), color space conversion (e.g., RGB to YUV), format conversion (e.g., INT10 to INT16, INT to FLT where INT represents integer and FLT represents float), normalization (e.g., YUV or RGB downsampling), generate data to be stored in memory (e.g., TPU native memory structure), write data to memory (e.g., writing to shared DRAM), compression (e.g., image compression such as PVRIC), weight compression (e.g., audio file compression where the audio file represents human speech).

In some implementations, the multimedia hardware accelerator 108 performs operations of an HiB—e.g., Host Interface Block. For example, the multimedia hardware accelerator 108 can read from a storage device, e.g., using Double Data Rate (DDR) access to random access memory (RAM) or other storage device.

The multimedia hardware accelerator 108 can access multimedia data for processing in different ways. By processing in different ways, different size buffers can be included in the multimedia hardware accelerator 108, e.g., to balance chip area requirements with latency and power savings. In some cases, techniques described can include one or more buffers, such as one or more SRAM buffers, that include memory sufficient to store 4K pixels by 8 lines of an image. Other sizes can be used, e.g., depending on implementation.

In general, the multimedia hardware accelerator 108 can process large chunks of data and use a large buffer to limit the number of calls to a data source. The multimedia hardware accelerator 108 can instead process small chunks of data and use a smaller buffer to limit chip area requirements at the expense of increasing a number of calls to a data source. For example, the multimedia hardware accelerator 108 can read pixels, where multimedia data 104 includes pixels, from left to right by row until the last row of pixels. This reading can require a buffer of size X. The multimedia hardware accelerator 108 can read in a stripe mode where multiple frames are processes simultaneously to obtain data for processing from the multiple frames. This reading can require a buffer that is smaller than X where the same amount of data can be read with more calls compared to the reading using the buffer of size X. The multimedia hardware accelerator 108 can read any suitable portion of data and be configured with any suitable buffer sufficient to store the read data.

The matrix processor 110 performs machine learning operations. For example, the matrix processor 110 can include one or more TPUs that perform machine learning operations using the multimedia data 104—e.g., a pre-processed version of the multimedia data 104 generated by the multimedia hardware accelerator 108. Machine learning operations can include performing multiplication, adding, or combining using one or more dedicated hardware circuit elements. Machine learning operations can include processing data to generate a prediction, where the matrix processor 110 can perform operations of one or more machine learning models. The generated prediction can be compared to one or more ground truth values for training the one or more machine learning models.

In some cases, the matrix processor 110 performs operations of a trained machine learning model. For example, after training one or more machine learning models, the matrix processor 110 can perform operations of the one or more machine learning models operating on the multimedia data 104—e.g., a pre-processed version of the multimedia data 104 generated by the multimedia hardware accelerator 108.

In some implementations, the multimedia hardware accelerator 108 processes data generated by a machine learning processor, e.g., the matrix processor 110. For example, the multimedia hardware accelerator 108 can obtain output from the matrix processor 110. The multimedia hardware accelerator 108 can process the data obtained as output from the matrix processor 110 before a subsequent operation is performed with the processed data. The subsequent operation can be transferring the data to another circuit element, e.g., to a CPU, GPU, display, storage device, or the like.

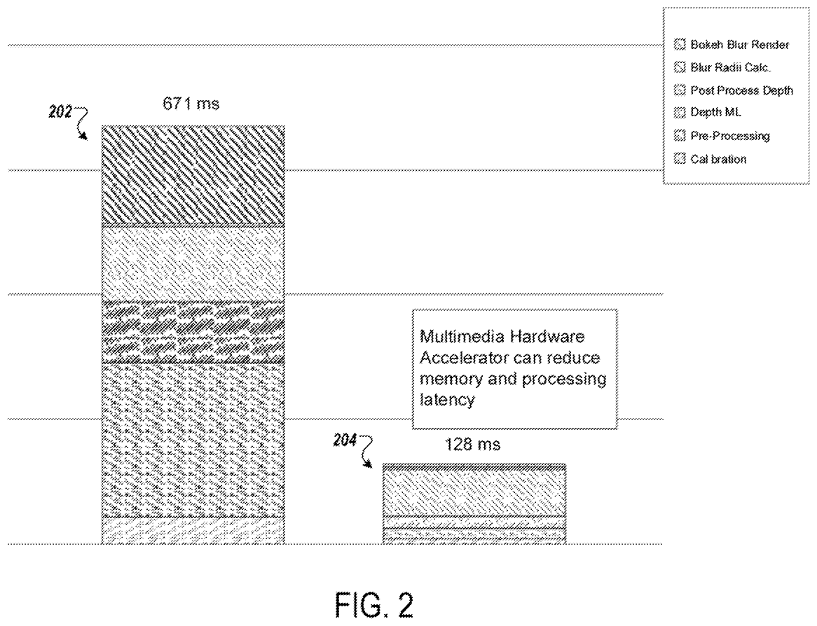

FIG. 2 shows latency improvements of the described techniques compared with a non-multimedia hardware accelerator approach. For example, FIG. 2 shows that performing one or more operations, including bokeh blur, blur radii calculation, post processing, machine learning depth, pre-processing, and calibration, requires 671 ms without using a multimedia hardware accelerator. With a multimedia hardware accelerator, a same result can be generated in 128 ms. The multimedia hardware accelerator, e.g., the multimedia hardware accelerator 108, can reduce latency by performing one or more operations instead of the operations being performed by a machine learning processor, such as a CPU, GPU, or TPU. Latency can be reduced through memory operation, e.g., read and write, reductions. Latency can be reduced through the inclusion of the multimedia hardware accelerator within a same compute cluster as one or more elements of a machine learning processor.

In some cases, a multimedia hardware accelerator can perform one or more pre or post-processing operations. For example, the left bar 202 shows a combination of time measurements indicating an amount of time for performing each of one or more operations to generate a computation result—e.g., training one or more models. The right bar 204 shows a combination of time measurements indicating an amount of time for performing each of one or more operations to generate the same or similar computation result. The one or more operations can include, e.g., bokch blur rendering, blur radii calculation, post processing, depth machine learning, pre-processing, and calibration. In some cases, an operation shown in FIG. 2 can include one or more operations. For example, pre-processing can include multiple processes such as downscaling an image or other data captured from a sensor, warping an image or other data from a sensor, or format conversion. In some cases, sensor data can be formatted to match machine learning network requirements. Post-processing can include quantization or up-sampling, e.g., to match a display resolution on a phone or video encoding image resolution. The left bar 202 and right bar 204 shows the latency difference between performing such operations using machine learning processors, such as a CPU, GPU, TPU, or DSP, versus performing such operations using the techniques described—e.g., with respect to the multimedia hardware accelerator 108 of FIG. 1. In particular, the right bar 204 shows latency associated with a multimedia hardware accelerator operating within a TPU. The latency values are shown in the order of the legend for each bar. Values are, in that order and in ms, 156.5, 4.9, 122.5, 96.6, 248.5, 42.3 for the left bar 202 for a total of 671 ms. Values are 5.7, 1.5, 77.7, 15.0, 16.6, 10.0 for the right bar 204 for a total of 128 ms.

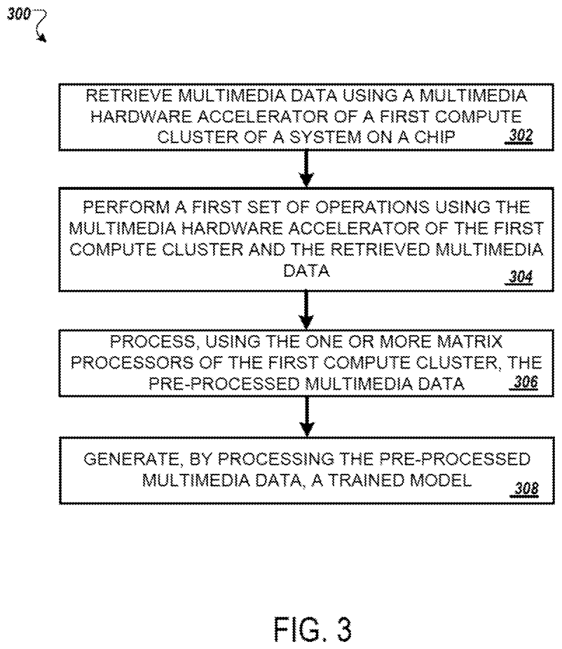

FIG. 3 is a flowchart of an example process 300 for multimedia hardware acceleration. For convenience, the process 300 will be described as being performed by a system of one or more computers or hardware circuits, located in one or more locations, and programmed appropriately in accordance with this specification. For example, a system, such as the system 100 of FIG. 1, can be configured to perform the process 300. Such a system can include one or more elements within an integrated circuit configured to perform operations described.

The process 300 includes retrieving multimedia data using a multimedia hardware accelerator of a first compute cluster of a system on a chip (302). In some cases, the first compute cluster can include (i) the multimedia hardware accelerator and (ii) one or more matrix processors that perform machine learning operations.

The process 300 includes performing a first set of operations using the multimedia hardware accelerator of the first compute cluster and the retrieved multimedia data (304). In some cases, the first set of operations include pre-processing the retrieved multimedia data. In some cases, the multimedia hardware accelerator includes circuit elements that are each configured to perform a respective operation in the first set of operations (304).

The process 300 includes processing, using the one or more matrix processors of the first compute cluster, the pre-processed multimedia data (306).

The process 300 includes generating, by processing the pre-processed multimedia data, a trained model (308). In some cases, the model can be trained for predicting features of subsequent multimedia data—e.g., multimedia data that has one or more features similar to the retrieved multimedia data. The subsequent multimedia data can be the same as the retrieved multimedia data or can include multimedia data retrieved subsequent to the retrieved multimedia data.

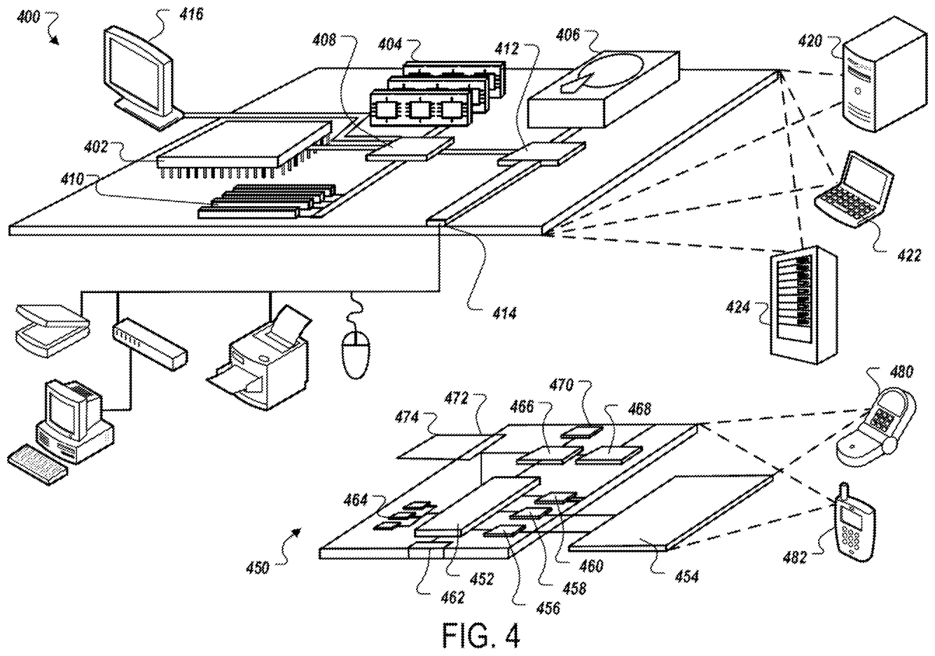

FIG. 4 is a diagram illustrating an example of a computing system used for multimedia hardware acceleration. The computing system includes computing device 400 and a mobile computing device 450 that can be used to implement the techniques described herein. For example, the computing device 400 or the mobile computing device 450 can perform operations described in reference to FIG. 1, FIG. 2, and FIG. 3.

The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 402 is a single threaded processor. In some implementations, the processor 402 is a multi-threaded processor. In some implementations, the processor 402 is a quantum computer.

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine readable mediums (for example, the memory 404, the storage device 406, or memory on the processor 402). The high-speed interface 408 manages bandwidth-intensive operations for the computing device 400, while the low-speed interface 412 manages lower bandwidth-intensive operations. Such allocation of functions is an example only. In some implementations, the high speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device, such as a mobile computing device 450. Each of such devices may include one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may include appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provide as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry in some cases. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 4G/6G cellular, among others. Such communication may occur, for example, through the transceiver 468 using a radio frequency. In addition, short-range communication may occur, such as using a Bluetooth, Wi-Fi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, among others) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

In general, use of “or” can refer to “and/or.” When providing a list of two or more items, the conjunction “or” can indicate any one of the items, any combination of a subset of the items, or all items in combination.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech, or tactile feedback or responses; and input from the user can be received in any form, including acoustic, speech, tactile, or eye tracking input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
retrieving multimedia data using a multimedia hardware accelerator of a first compute cluster of a system on a chip, wherein the first compute cluster includes (i) the multimedia hardware accelerator and (ii) one or more matrix processors that perform machine learning operations;
performing a first set of operations using the multimedia hardware accelerator of the first compute cluster and the retrieved multimedia data, wherein the first set of operations include pre-processing the retrieved multimedia data, wherein the multimedia hardware accelerator includes circuit elements that are each configured to perform a respective operation in the first set of operations;
processing, using the one or more matrix processors of the first compute cluster, the pre-processed multimedia data; and
generating, by processing the pre-processed multimedia data, a model trained for predicting features of subsequent multimedia data.

2. The method of claim 1, wherein the one or more matrix processors of the first compute cluster include a Tensor Processing Unit (TPU).

3. The method of claim 1, wherein performing the first set of operations using the multimedia hardware accelerator of the first compute cluster comprises:
compressing or decompressing the retrieved multimedia data.

4. The method of claim 1, wherein performing the first set of operations using the multimedia hardware accelerator of the first compute cluster comprises one or more of the following: cropping, rotating, color space conversions, normalization, downscaling, reading to memory, or writing to memory.

5. The method of claim 1, wherein performing the first set of operations using the multimedia hardware accelerator of the first compute cluster comprises (i) cropping, (ii) rotating, (iii) color space conversions, (iv) normalization, (v) downscaling, (vi) reading to memory, and (vii) writing to memory.

6. A system comprising one or more computers and one or more storage devices on which are stored instructions that are operable, when executed by the one or more computers, to cause the one or more computers to perform operations comprising:
retrieving multimedia data using a multimedia hardware accelerator of a first compute cluster of a system on a chip, wherein the first compute cluster includes (i) the multimedia hardware accelerator and (ii) one or more matrix processors that perform machine learning operations;
performing a first set of operations using the multimedia hardware accelerator of the first compute cluster and the retrieved multimedia data, wherein the first set of operations include pre-processing the retrieved multimedia data, wherein the multimedia hardware accelerator includes circuit elements that are each configured to perform a respective operation in the first set of operations;
processing, using the one or more matrix processors of the first compute cluster, the pre-processed multimedia data; and
generating, by processing the pre-processed multimedia data, a model trained for predicting features of subsequent multimedia data.

7. The system of claim 6, wherein the one or more matrix processors of the first compute cluster include a Tensor Processing Unit (TPU).

8. The system of claim 6, wherein performing the first set of operations using the multimedia hardware accelerator of the first compute cluster comprises:
compressing or decompressing the retrieved multimedia data.

9. The system of claim 6, wherein performing the first set of operations using the multimedia hardware accelerator of the first compute cluster comprises one or more of the following: cropping, rotating, color space conversions, normalization, downscaling, reading to memory, or writing to memory.

10. The system of claim 6, wherein performing the first set of operations using the multimedia hardware accelerator of the first compute cluster comprises (i) cropping, (ii) rotating, (iii) color space conversions, (iv) normalization, (v) downscaling, (vi) reading to memory, and (vii) writing to memory.

11. One or more computer storage media encoded with instructions that, when executed by one or more computers, cause the one or more computers to perform operations comprising:
retrieving multimedia data using a multimedia hardware accelerator of a first compute cluster of a system on a chip, wherein the first compute cluster includes (i) the multimedia hardware accelerator and (ii) one or more matrix processors that perform machine learning operations;
performing a first set of operations using the multimedia hardware accelerator of the first compute cluster and the retrieved multimedia data, wherein the first set of operations include pre-processing the retrieved multimedia data, wherein the multimedia hardware accelerator includes circuit elements that are each configured to perform a respective operation in the first set of operations;
processing, using the one or more matrix processors of the first compute cluster, the pre-processed multimedia data; and
generating, by processing the pre-processed multimedia data, a model trained for predicting features of subsequent multimedia data.

12. The media of claim 11, wherein the one or more matrix processors of the first compute cluster include a Tensor Processing Unit (TPU).

13. The media of claim 11, wherein performing the first set of operations using the multimedia hardware accelerator of the first compute cluster comprises:
compressing or decompressing the retrieved multimedia data.

14. The media of claim 11, wherein performing the first set of operations using the multimedia hardware accelerator of the first compute cluster comprises one or more of the following: cropping, rotating, color space conversions, normalization, downscaling, reading to memory, or writing to memory.

15. The media of claim 11, wherein performing the first set of operations using the multimedia hardware accelerator of the first compute cluster comprises (i) cropping, (ii) rotating, (iii) color space conversions, (iv) normalization, (v) downscaling, (vi) reading to memory, and (vii) writing to memory.
